(19) United States
(12) Patent Application Publication
(10) Pub. No.: US 2007/0264485 A1
(43) Pub. Date: Nov. 15, 2007

(54) AEROGEL-BASED ENCLOSURE SYSTEMS

(75) Inventors: Christopher J. Stepanian, Somerville, MA (US); Shahrooz Zaghi, Washington, DC (US)

Correspondence Address: ASPEN AEROGELS INC.;IP DEPARTMENT, 30 FORBES ROAD, BLDG. B, NORTHBOROUGH, MA, 01532, US

(73) Assignee: Aspen-Aerogels, Inc., Northborough, MA (US)

(21) Appl. No.: 11/748,914

(22) Filed: May 15, 2007

Related U.S. Application Data
(60) Provisional application No. 60/747,212, filed on May 15, 2006.

(51) Int. Cl. B05D 7/00; B32B 3/26

(52) U.S. Cl. 428/304.4; 427/407.1

(57) ABSTRACT

Enclosures of several type useful in transportation or thermally sensitive materials comprising a fiber reinforced aerogel material is described. Enclosures may take several forms and the aerogel material may be encapsulated with polymeric materials. Various methods of manufacturing such enclosures are also described.

### CROSS-REFERENCES TO RELATED APPLICATIONS

This application claims benefit of priority from U.S. Provisional Patent Application 60/747,212 filed May 15, 2006 which is incorporated herein by reference in its entirety as if fully set forth.

### FIELD OF INVENTION

The present invention generally pertains to enclosures comprising aerogels and specifically flexible fiber-reinforced aerogels and methods of manufacturing the same.

### SUMMARY OF THE INVENTION

Embodiments of the present invention describe an enclosure comprising an aerogel material, wherein said aerogel material is preferably in blanket form and may be based on silica, titania, zirconia, alumina, hafnia, yttria, ceria or a combination thereof. Alternatively the aerogel may be based on: urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural or a combination thereof.

Further alternatively, the aerogel material may comprise: silica-PMMA, silica-chitosan, silica-polyether or a combination thereof. The other component of the enclosure systems of the present invention comprises a non-aerogel material exemplified but not limited to: elastomers, thermoplastics, thermosets, metals, semi-metals, ceramics, foams, biomaterials, or any combination thereof. The volume of these enclosures may be defined by the internal surfaces of said non-aerogel material or the aerogel material. Optionally, the aerogel material, the non-aerogel material or both are secures. In alternate embodiments the insulated enclosure further comprises: a desiccant material, a heating element, a cooling element, a temperature sensor, a pressure sensor, a humidity sensor or a combination thereof.

The enclosure of may be flexible, comprise a fluid or both wherein said fluid is characterized by a liquid, gas or both. Further, the components of the enclosure systems may comprise pre-shaped prior to use in the final structure. Practical applications of said enclosure systems include but are not limited to: pharmaceutical product containers, animal/human organ containers, electronic device containers hazardous material containers, food transport containers, shipping containers compliant with the International Standards Organization (ISO), shipping trailers, mailing enclosures and numerous others.

### DESCRIPTION

Enclosures of the present invention may comprise one or more walls, an interior space and a fiber reinforced aerogel material wherein the aerogel material is located in or about at least one of the walls. In an example, two walls together sealed at the edges can form an enclosure such as an envelope. Six defined walls may make a container. Sometimes, the number of walls may not be as distinct due to the complexity of the structure. However, enclosure may be defined by the interior space and materials surrounding them in terms of walls or an equivalent structure. Such walls or equivalent structures may include aerogels and specifically fiber reinforced aerogels. Alternatively, the aerogels themselves may make up the wall or an equivalent structure. Such aerogels may be encapsulated through different means and using other laminar materials such as polymeric films. One example of an equivalent structure is a spherical structure where either it may be viewed to have several walls or only one wall which makes the surface of the sphere. Irrespective of such differences, such equivalent structures are considered to be within the scope of the present invention.

Aerogels are well known for their superior thermal insulation properties. An improved composite form incorporates fiber reinforcement resulting in a flexible material with low thermal conductivity. With appropriate reinforcement, such composites can conform to most any three dimensional surfaces such as curved, angular, discontinuous or otherwise non-flat. Furthermore, many enclosure systems can derive thermal insulation benefits by incorporating fiber-reinforced aerogels with minimal disruption to the overall design.

Within the context of embodiments of the present invention “aerogels” or “aerogel materials” along with their respective singular forms, refer to gels containing air as a dispersion medium in a broad sense, and refer to gel materials dried via supercritical fluids in a narrow sense. Furthermore, the chemical composition of aerogels can be inorganic, organic (including polymers) or hybrid organic-inorganic. When flexible is used to describe the enclosure, it means at least one of the walls that form the enclosure is flexible. In a specific embodiment such flexibility is such that the wall can be bent to at least 30 degrees. In yet another specific embodiment, such 30 degree bending is achieved while the radius of curvature is less than or equal to 12″ inches.

Examples of inorganic aerogels include, but are not limited to silica, titania, zirconia, alumina, hafnia, yttria and ceria. Organic aerogels can be based on, but are not limited to, compounds such as, urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural, a member of the polyether family of materials or combinations thereof. Of course carbon aerogels are also of interest. Examples of organic-inorganic hybrid aerogels are, but not limited to, silica-PMMA, silica-chitosan, silica-polyether or possibly a combination of the aforementioned organic and inorganic compounds. Published US patent applications 2005/0192367 and 2005/0192366 teach extensively of such hybrid organic-inorganic materials and are hereby incorporated by reference in their entirety.

The preferred synthetic route for preparing aerogels involves the sol-gel process although other gel forming methods such as the “water glass process” are equally applicable. The sol-gel process typically involves gel formation from a sol solution comprising precursor materials which polymerize into a gel network. Subsequent drying, entails removal of the solvent from the gel pores ultimately resulting in a dried gel, or aerogel material. The sol-gel process is described in detail in Brinker C. J., and Scherer G. W., Sol-Gel Science; N.Y.: Academic Press, 1990; hereby incorporated by reference.

Drying plays an important role in engineering the properties of aerogels, such as porosity and density which in turn influence the material thermal conductivity. To date, numerous drying methods have been explored. U.S. Pat. No. 6,670,402 teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. Finally, U.S. Pat. No. 5,565,142 describes subcritical drying techniques. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

Aerogel composites reinforced with a fibrous batting, herein referred to as “blankets”, are particularly useful for applications requiring flexibility since they are highly conformable and provide low thermal conductivity. Aerogel blankets and similar fiber-reinforced aerogel composites are described in published US patent application 2002/0094426A1 and U.S. Pat. Nos. 6,068,882, 5,789,075, 5,306,555, 6,887,563, and 6,080,475.

In the preferred embodiments, enclosure systems (e.g. packaging) with aerogel blankets are described while it hereby explicitly noted that that other forms of aerogels, i.e. particulates, monoliths etc., may be used in conjunction with, or in lieu of the aerogel blankets. In general, enclosures derived from aerogel materials may conform to the aerogel material or vise versa. Furthermore, in an enclosure (e.g. packaging) design the aerogel material (e.g. blanket) can be placed as a lining, external layer, integrated inter-layer (e.g. within the walls of packaging) or a combination thereof. Furthermore, aerogels may be fastened to an enclosure system or left unsecured. Of course by the virtue of configuring the aerogel material in a sandwiched arrangement, securing the same is achieved. In some embodiments, aerogel plies are secured to one another and/or the enclosure material via tags, stitches, rivets, staples, adhesives, needle-punching or any combination thereof. Virtually any material may be used in conjunction with aerogel materials to construct insulating enclosures. In addition to aerogels, materials for constructing the enclosures can comprise polymeric (including elastomeric and thermoplastic), metallic, semi-metallic, ceramic, natural materials (e.g. cellulosic), or any combination thereof. Metallized (aluminized in a preferred embodiment) polymeric films may be used in conjunction with aerogels in any of the embodiments of the present invention. In terms of properties, it may be desired to employ one or more plies of materials that are electrically conducting, electrically semi-conducting, electrically insulating, thermally conducting, thermally insulating, optically transparent, optically translucent, optically opaque, compressible, incompressible, flexible, resilient or a combination thereof. The enclosures may be pre-shaped whereby the enclosure material and the blanket are maintained at a particular arrangement. Where the enclosures are shape-less (i.e. flexible), the aerogel blankets may predominantly set the overall shape. Additionally, pressure sensitive adhesives may be used to secure an aerogel blanket to an interior/exterior surface of an enclosure. In this arrangement, further application of a vacuum pressure to aerogel, opposite side of the adhesive would result in an enhanced securing mechanism.

In one method of construction, a blanket(s) may be fitted to an enclosure with or without any securing mechanism. Alternatively, the blanket may be pre-shaped and combined with a pre-shaped or shapeless enclosure material. In some instances it may be desired to pre-shape both such that the blanket is subsequently mated with a corresponding enclosure surface. Aerogels can be pre-shaped in many ways. One method includes inserting between two relatively more rigid elements (i.e. rigid plastic, metal, etc.), which are then subsequently shaped. For example, a wire mesh may be used to force a blanket to conform to the contours of a surface when the aerogel is between said surface and wire mesh. Another example involves placing the blanket between two thermoplastic elements, which upon heating are shaped (e.g. bent, twisted, etc.) thereby inducing, and maintaining the same shape for the blanket upon cooling and rigidifying. Another method may involve a coating a blanket held to a particular conformation, whereby upon curing the coating, said conformation is retained. Another method involves an air or light sensitive structure that, when removed from packaging, begins to harden thereby forming a conformed blanket.

In general, enclosures may be constructed from connecting individual pieces to define an interior volume. Said individual pieces may have any shape such as: flat, spherical, hemispherical, cylindrical, hemi cylindrical, half-pipe, annular, helical, navicular, corrugated, grooved, rippled, and various others. They can be co-secured via any securing means sufficient to maintain the integrity of the resulting enclosure during its intended use. Alternatively, enclosures may be constructed from a one-piece unit which upon manipulation (folding, bending, etc.) and securing results in an enclosure. FIG. 5 depicts a one-piece unit which upon folding results in a box. Analogously, a one-piece unit for constructing spherical, conical and other shapes may used. Securing means include but are not limited to: adhesives, stitches, staples, Velcro, nails, screws, clamps, welding (RF, metallic, etc.), heat sealing, or a combination thereof. The pieces or parts of a one-piece unit may be designed with mating or interlocking features which allow co-securing the same without any other means.

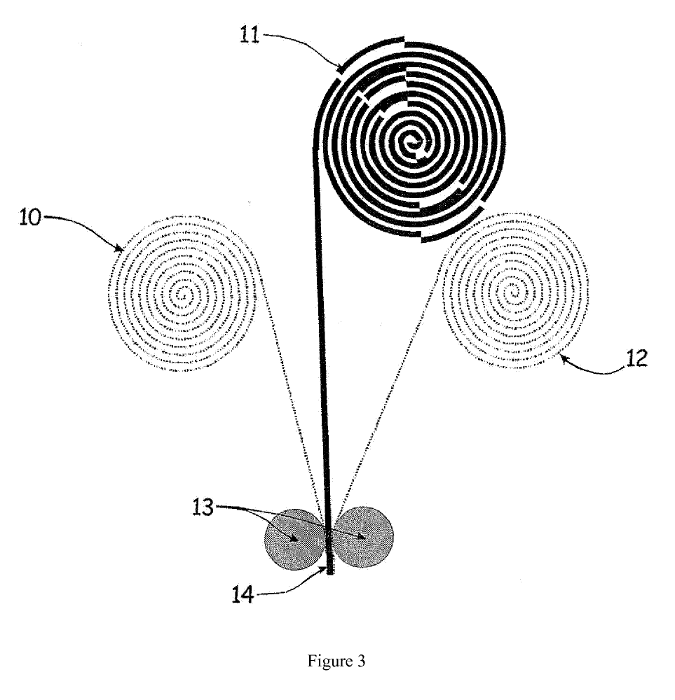

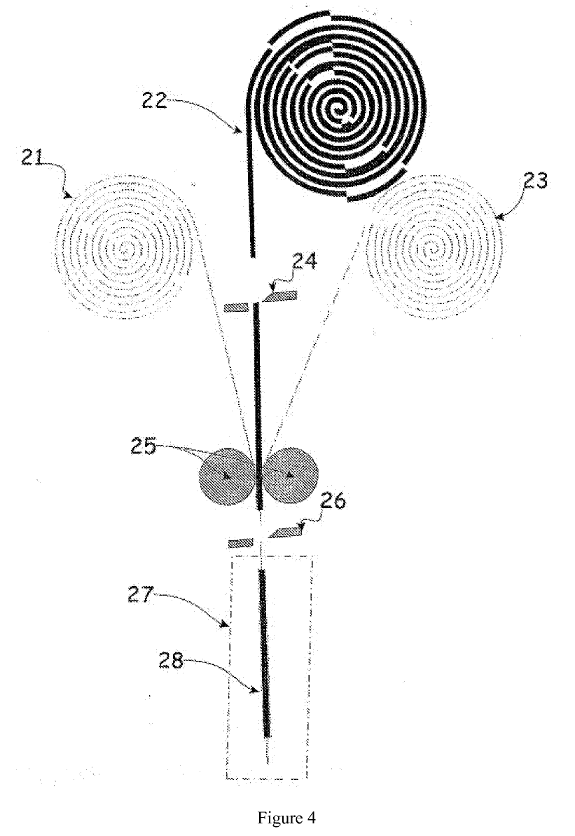

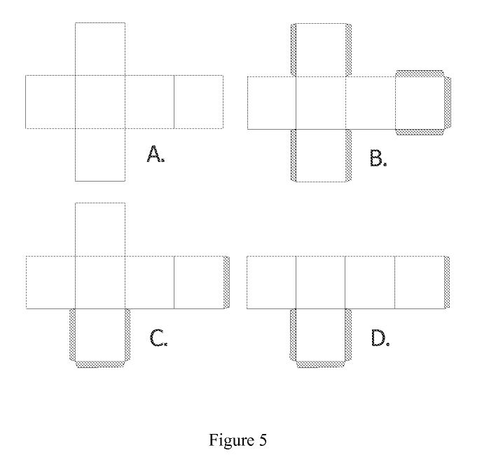

Another embodiment relates to automated manufacture of insulated strips and labels suitable for enclosing vessels such as soda containers and beer containers with conventional labeling on the outside of the container. This insulated labeling system's thermal performance may also be augmented through the use of vacuum while the insulated label is being manufactured. Wrinkling of the outer surface of the encapsulating membrane may be remedied by an unattached, shrink-on type label over the surface of the material. This process may be accomplished at atmospheric pressure or under vacuum. The method for fabrication consists of an inner, heat sealable film, an insulating layer of aerogel blanket, and an outer, heat sealable layer capable of receiving printing. These three layers would be brought together and either partially or completely sealed, thereby either covering or encapsulating the aerogel blanket (see FIGS. 3 and 4.) Partial or hard vacuum may be drawn on either all the components or on just the laminate before the final seal is made.

A rough vacuum in the sealed label of approximately 100 Torr would result in a decrease of thermal conductivity by nearly a factor of two. The thermal performance of this partially evacuated label would result in a thermal resistance approximately an order of magnitude greater than that of an organic polymer-based batting, alone. Alternatively, other gases such as nitrogen, argon or helium may be filled or partial vacuum under these gaseous environment may be established.

The process for manufacture of such product is exemplified in a non-limiting fashion in FIG. 3. The polymer films 10, 12 are used to encapsulate the aerogel blanket 1. A continuous version involves conveyance of all three components through heated nip rollers 13 that seal the edges the films 10, 12 to each other or to the aerogel blanket 11. The films may either be wider than the aerogel blanket or the same width as the blanket depending on the type of adhesion desired. The resulting rolled good 14 should be flexible and generate only a minimum of dust. A more refined process for making such an insulated product would resemble that shown in FIG. 4. The films, aerogel blanket, and assembly machinery may be placed in either an alternative atmosphere such as argon to minimize thermal conductivity, in a partial vacuum, or both. This is illustrated in an insulated article 28. The polymer films 21, 23 are used to encapsulate the aerogel blanket 22. A typical method for continuous manufacture includes passing all three components through heated nip rollers 25 that seal the edges the films 21, 23 to each other or to the aerogel blanket 22. An optional first cutting means 24 allows for the encapsulation of discrete segments of aerogel blanket. The films may either be wider than the aerogel blanket or the same width as the blanket depending on the type of adhesion being targeted. The resulting rolled good 28 should be flexible and generate only a minimum of dust. Optional second cutting means 26 would enable the creation of individual, either fully or partially sealed packages. Partially sealed packages could be introduced into an alternative atmosphere 27, a partial vacuum, or both and subsequently sealed to create a very low thermal conductivity component. An evacuated part may have the tendency to wrinkle when used in an atmospheric pressure environment. One way to mitigate this tendency is to wrap the wrinkled insulation around the component to be insulated, shrink-wrap printed layer around the insulation, and shrink the sleeve to the insulation. This would result in a solution that has both low thermal conductivity and a more aesthetic appearance.

In an embodiment, an aerogel blanket(s), with or without other forms of aerogels (e.g. particulates etc.) is laminated to at least one surface of the enclosure. This may be achieved prior to or after the enclosure is formed. That is, the blanket may be laminated to a piece (or pieces) on at least one surface prior to forming the enclosure from said piece(s). One non-limiting mode of lamination involves bonding or impregnating superposed layers, at least one of which is an aerogel blanket and another is a piece of the enclosure, with a resin and compressing said layers under heat.

In an embodiment, the pieces constituting the walls of and enclosure comprise an integral sealed compartment, said compartment comprises a fluid such as a liquid, gas or both. Examples of gases include, but are not limited to: air, N₂, He, Ar, Xe and the like. Suitable liquids include organic or aqueous liquids preferably with thermal stabilizing properties. Alternatively, the sealed compartment(s) comprise phase change materials.

In another embodiment, the interior volume of the enclosure comprises a fluid. That is, the ambient surrounding the contents retained by the enclosure (e.g. human organs, biomaterials, food, etc.) comprises certain fluids. This scheme may be desirable for reducing/preventing material degradation of the product enclosed. As in the previous case, said fluid may be characterized as liquid, gas or both. Exemplary gases include but are not limited to: air, N₂, He, Ar, Xe. Suitable liquids may comprise organic (e.g. hydrocarbons) or aqueous liquids. As in the case of hypothermic organ transport, a sterile environment during storage as well as during the handling of the organ is of utmost concern requiring maintenance of a proper temperature of tissues during transport in order to maintain tissue integrity. An enclosure for transport of donor organs may include a volume wherein the organ is in a protective fluid, said enclosure further comprising pliable sidewalls so that any external pressure applied is equally distributed throughout the fluid of the container, thereby protecting the organ from pressure injury during transport. Incorporation of an aerogel blanket in this design will enable longer thermal regulation within the enclosure without any significant added weight. Preferably the aerogel blanket is mounted to the container such that it does not come in contact with the internal fluid medium. U.S. Pat. No. 4,951,482 describes organ transport enclosures in more detail and is hereby incorporated by reference.

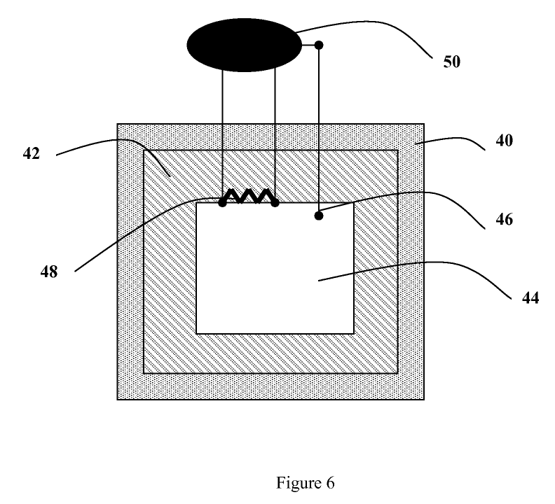

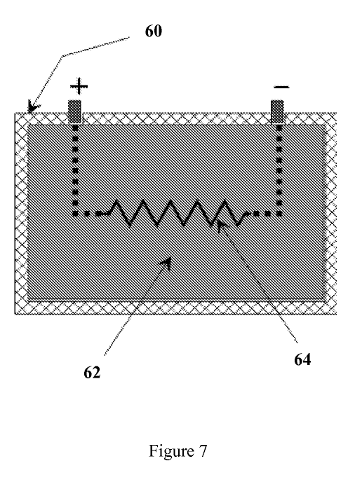

In an embodiment, the enclosure systems of the present invention comprise a sensor(s) connected to a display unit for indicating the temperature, humidity, or pressure of the ambient surrounding the contained item. Said sensors may further be part of a feed back system enabling continuous adjustment of the ambient conditions to desired preset levels. An example is described in published US patent application 2005/0016198 which discloses a storage system with a temperature controlled inner volume. FIG. 6 depicts a thermally controlled enclosure system comprising an aerogel insulation 40, placed about an inner container 42. The interior surface of the inner container delimits an internal volume 44 where the temperature sensitive items are stored. A sensor 46 monitors the internal volume temperature and relays the data to a control unit 50, which in turn is connected to a heating element 48.

In one embodiment, a phase change materials is used in addition to the aerogel material. Phase change materials have the capability to retain heat in the form of a phase change, where upon cooling, and reverting to the original phase said heat is released. The advantage of utilizing phase change materials in addition to aerogel materials in enclosures is that not only the enclosure is well insulated, but it can react to temperature changes thereby regulating the same.

For transport of moisture sensitive products such as pharmaceuticals, a dry atmosphere is usually necessary. In yet another embodiment, a relatively moisture free ambient environment is provided in aerogel-insulated enclosures of the present invention. Desiccant materials such as silica gel, Montmorillonite clay, calcium oxide or calcium sulfate may be inserted within a semi-permeable enclosure able to intake the ambient air about the moisture sensitive product, thereby reducing moisture content. In addition to, or in lieu of desiccant materials, other gas adsorbing materials such as activated alumina, activated carbon, metal salts, phosphorous compounds, activated charcoal, crystalline metal aluminosilicates, activated bentonites, known molecular sieves and various others, may be used. Typically, a selected gas adsorbing material is placed within one of two forms of common desiccant containers. One form of desiccant container is a flexible bag that is formed of a breathable material, wherein gaseous exchange may occur through the entire container except through sealed ends of the bag or packet. A more common form of desiccant container is a cylindrical-shaped canister made of solid molded plastic having one or two breathable ends. US published application US2005/0274259A1 and U.S. Pat. No. 5,759,241 describe such containers in more detail and are hereby incorporated by reference. These containers may be integrated into the inner volume of an enclosure or separately secure thereto.

Another embodiment pertains to mailing envelopes which includes a wide range of types including, but not limited to: paper envelopes, padded envelopes, reinforced and stiffened envelopes, and the like. Padded envelopes for shipment of fragile items are of particular interest. Typically padded envelopes are utilized for substantially two-dimensionally shaped items and comprise an outer cover attached to an inner padded lining in contact with the shipment item. The most popular design of padded envelopes comprises an inner lining of bubble-wrap attached to an outer cover comprising a paper material such as kraft paper. Paper materials as used herein refers to any material or composite material having a predominantly wood pulp content. Examples of such materials include, but are not limited to, paper, cardboard, artificial paper substitutes, and paper lined with metallic or plastics materials. US Patent application 2004/0265521A1, and U.S. Pat. No. 6,139,188 describe such padded envelope designs, along with methods for manufacture thereof. Other examples of other envelopes include U.S. Pat. Nos. 3,768,724, 5,727,686. In one embodiment of the present invention, an aerogel material is used in lieu of, or in conjunction with, the padding element (e.g. bubble-wrap) in a typical padded envelope design. Here, an aerogel blanket may serve as the padding without any significant added bulkiness to the envelope and while providing superior thermal and electrical insulation. Aerogel blankets with thicknesses as low as 1.5 mm (Thermal conductivity better than 15 mW/mK), are commercially available from Aspen Aerogels Inc. (Northborough, Mass.) In a preferred form of this embodiment, the aerogel blanket is encased a material substantially impervious to micro-particulates which may be released from the aerogel blanket. In general, polymeric films such as but not limited to, Polyethylene, Polypropylene, Polyester, PTFE, Tyvek® and the like are suitable for this purpose.

Another embodiment deals with containers which are useful in shipping products that are perishable or otherwise require a stable temperature range different than that of ambient. Most often, such containers include cold packs and/or thermal barrier side walls which help to maintain a refrigerated environment throughout the internal volume of the container. Some designs may incorporate a heating element activated by air current or a resistive heating element. A specific example involves using thermostatically controlled cooling elements such as those operating via compression/expansion of heat transfer fluids such as CFC's, HCFC's, ammonia and other freons. Such enclosure systems are also described in U.S. Pat. Nos. 5,454,471, 5,052,369 4,806,736 4,578,814 5,216,900, 5,924,302, 6,055,825 describe general packaging designs for maintaining a desired temperature range for temperature-sensitive items.

Other similar applications involve transport of hazardous wastes, human or animal organs, or temperature sensitive food. Hazardous materials transport is described in published US application US2005/0023282A1. Organ transport is described in US5681740 and US2005/0208649A1. These references may be modifies according to embodiments of the present invention thereby resulting in improved enclosure systems.

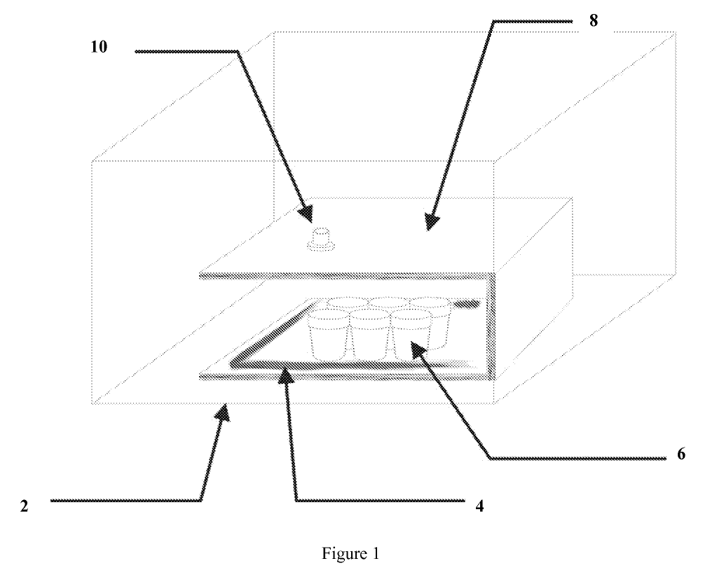

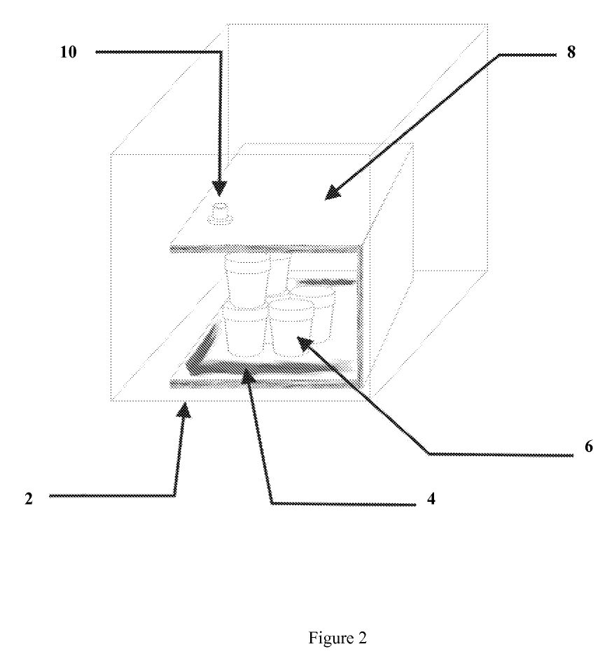

In one embodiment, the enclosure system is designed to retain contents at reduced temperatures. Packaging based on blankets can provide an effective, economical and practical method for low temperature shipment of heat sensitive substances. For instance, shipment of frozen goods such as ice cream may be achieved by appropriate packaging which comprises an aerogel material. Referring to FIGS. 1 and 2, a packaging system is shown wherein the aerogel blanket 8 is placed in the interior of the packaging, and about the frozen products 6 (ice cream). The outer packaging material 2 preferably comprises a thermal insulating material, which is also suitable for handling. Examples include, cardboard, plywood, foams and the like. The outer packaging may also be omitted if the enclosure is sufficiently tough to resist puncture and the payload is resistant to damage in its frozen form. As shown in the figures the blanket(s) are secured to one another, and optionally to the outer packaging material via an adhesive 4. Further optional, an evacuation port 10 is included for maintaining sub atmospheric pressures.

It is also noted that at decreasing temperatures, the contribution of radiative conduction becomes increasingly significant. That is, when the temperature differential is larger, such as where an enclosed volume is significantly colder than that of the external ambient the radiative heat transfer is of more concern. To address this issue, opacifiers may be added to aerogels to reduce the radiative component of heat transfer. Examples of opacifiers include: B₄C, Diatomite, manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or a mixture thereof. Furthermore, radiation shielding materials such as aluminum foil or mylar (aluminized polyester) may be used.

Aerogel-insulated enclosures functioning as fluid containers are further discussed wherein said enclosure system substantially maintains the temperature of a fluid over a period of time. Depending on the construction of the system, a fluid's temperature may be substantially maintained for days and even weeks. As used herein “substantially maintained” refers to a temperature range about the original fluid temperature (prior to introduction into enclosure system) where said fluid is still fit for original intended use. One example is storage of hot fluids in cold climates or vise versa, further exemplified by the double walled canteens employed by the US military in extreme climates. The space between the canteen walls can be filled with aerogel beads, particulates, powder, blanket or a combination thereof. This unique enclosure system would show superior performance over single walled cold weather canteen designs by at least and order of magnitude (10×). Optionally the space between the canteen walls are maintained at reduced pressures for added thermal performance. In one instance these canteens are designed to provide the maximum protection against freezing made possible by the inclusion of aerogel insulation. Based on early studies, a 0.25″ aerogel layer at atmospheric pressure should satisfy the 4 hour/15% freeze criterion required by the military. Excluding the losses through the canteen neck, the insulating effect of the aerogel should increase at least an order of magnitude (10×) under moderate vacuums. An additional advantage is that even if the external wall is punctured, loosing the vacuum, the thermal insulation qualities afforded by the aerogel exceed that of quiescent air. This could translate into a substantially longer freeze protection period than 4 hours.

Although the canteen is designed for cold weather use, it may serve to satisfy needs in the opposite environment. Other early studies at Aspen Systems indicate that the thermal insulation afforded by the canteen in warm climates will be, at least, three times longer than the corresponding cold climate use. This estimation is based on the assumption that the canteen will be filled with a 50% ice/water solution initially, will be subjected to 120° F. ambient temperatures, and should maintain a temperature of 70° F. or for at least about two days or at least about 1 day or at least about 12 hours.

Another embodiment pertains to a battery, such as those commonly employed in motor vehicles, which is stored in a temperature-controlled enclosure. Typically, the amount of power a battery can produce is negatively influenced by the cold. At 0° F. (−17.8° C.), a normal battery will deliver only about 40 percent of the power it would at 80° F. (26.7° C.). This reduced performance is not permanent, and may be reversible. If a battery is not fully charged, however, the electrolyte can freeze and damage the plates or crack the container. Batteries at usable charge states will not freeze at temperatures above −20° F. A system for providing an aerogel insulated enclosure for batteries will therefore allow for improved performance. This insulation system can consist of two sealed layers of high performance polymeric film. Said films can be a laminate of different polymers to ensure strong performance in the under-hood environment. The film must additionally satisfy criteria such as acid and base resistance (including battery acid), puncture resistance, heat resistance (−40° C.-100° C.) and oil/gasoline resistance. Candidate polymer materials might include polypropylene, Tedlar® or polyamide (Nylon) films. Additional layers of metallic elements may also be used to decrease heat loss and increase film toughness. The aerogel material used (in the shape of a bag) for the enclosure is in blanket form which can stand handling and vibration with minimized degradation. Hard points, locations where bolts pass through the blanket or where the battery rests, can be made of a dense (or densified) fiber reinforced aerogel composite suitable for withstanding compressive loads. Optionally this composite may be also pre-shaped. This composite material, while being an excellent insulator, can stand significant static load without failure. Heating can be performed by film heaters either integrated into the aerogel blanket bag or bonded onto the inner surface of the enclosure as needed.

FIG. 5 illustrates the design by which a fiber reinforced aerogel or an aerogel blanket is cut such that an enclosure is created from a single piece of aerogel blanket. Illustrated designs can be folded at the indicated lines to form an enclosure. In some designs, additional flaps (the shaded areas) are provided for better sealing of the edges. Such edges are optional and may be provided for all the edges or selected edges. Additionally one or more zippers may be provided in the edges for proper sealing. Such zippers may especially be useful when such edges are formed by the free hanging edges of the illustrated designs (i.e. the edges of the resulting enclosure not formed by the folding of the indicated lines). Zippers may be of the form commercially available in the trade name such as Ziploc or similar.

One design is illustrated in FIG. 6 wherein a battery 62 is encased in an aerogel insulation bag 60. In such instance the shape of the internal volume is defined by the external surfaces of the battery. An integrated resistive heating film 64 further assists in providing a temperature-controlled environment.

Alternatively, a double walled, hard polymer box may be used instead of the aerogel/film insulation. This design is more robust, durable and able to withstand various environmental elements. This design however, requires pre-shaped parts to fit a given battery if it is intended to be space-saving in addition to highly insulating.

A pharmaceutical product container, an animal/human organ container, an electronic device container, a hazardous waste container, a food transport container, a trailer container, a mailing enclosure (envelope) or variations thereof may be constructed by the various embodiments described in the present application.

In an embodiment, the enclosures may be in the form of already existing structures. For example, a refrigerated truck or a cryogenic tank may already form the boundaries of an interior space. Aerogel or aerogel blanket layers may be attached either to the interior surface or the exterior surface of the walls of such trucks to provide a better insulated interior space. Another example of an enclosure is a container where liquids or gases are stored. Such enclosures may be better insulated by employing fiber reinforced aerogels. Such systems may have two layers of walls with a space in between where aerogels or aerogel blankets may be located. When such containers are required to handle hazardous materials, any requirements of equipments needed to handle such hazardous materials may also be applicable to the aerogel materials. Such requirements may include compatibility with Liquefied natural Gas, hydrogen, oxygen, nitrogen, helium or argon. Several standard specifications or requirements are articulated by standard making bodies such as ISO or ASTM for such compatibility and aerogel materials or any ingredients of the insulation shall adhere to or comply with such standards in some embodiments of the present invention. ASTM G 63 for example provides guidelines for selecting materials used in oxygen environments and is incorporated by reference along with other standards referred therein. Autogenous Ignition Temperature (AIT), Oxygen Index (OI), and Heat of Combustion (HoC) are some of the indices helpful in evaluating aerogels for oxygen service. The following ASTM standards are also relevant and all of them are incorporated by reference here.

### ASTM G 72-82 (Re-approved 1996) Test Method for Autogenous Ignition Temperature of Liquids and Solids in a High-Pressure Oxygen-Enriched Environment. (American Society for Testing and Materials, Philadelphia, Pa.)

ASTM D 2863-00 Standard Test Method for Measuring the Minimum Oxygen Concentration to Support Candle-like Combustion of Plastics (Oxygen Index), (American Society for Testing and Materials, Philadelphia, Pa.) or equivalent such as ASTM G 125¹ ¹ ASTM G 125-95, Standard Test Method for Measuring Liquid and Solid Material Fire Limits in Gaseous Oxidants. (American Society for Testing and Materials, Philadelphia, Pa.)
ASTM D 4809-95 Test Method for Heat of Combustion for Liquid Hydrocarbon Fuels by Bomb Calorimeter (Precision Method), (American Society for Testing and Materials, Philadelphia, Pa.) or equivalent such as ASTM D 5865-99² ² ASTM D 5865-99, Standard Test Method for Gross Calorific Value of Coal and Coke. (American Society for Testing and Materials, Philadelphia, Pa.)

Aerogels in particular aerogel blankets may also need to be compatible with low temperatures when used in cryogenic conditions. Aerogel materials or aerogel blankets may be used as a single layer or a plurality of layers. Such plurality of layers may be pre-made and inserted into any space designated for insulation materials or they may be wrapped around, fit in or around an element or a surface to be insulated.

In yet another embodiment, enclosures of several embodiments may be sealed using zippers of the likes of the commercially available Ziploc. This is especially useful when the enclosure is formed as an envelope or a pouch. Such enclosures may be useful in the transport of temperature sensitive materials such as pharmaceuticals, human organ, biotechnology products or the like.

The enclosures of the present invention may additionally include visible sensors, i.e. sensors providing color coded temperature information. For example, some materials such as meat need to be stored under certain temperature and if the temperature goes below certain value, the sensor will change color which is seen outside the enclosure. Hence, without resorting to opening the enclosure, one can ascertain the condition of the elements inside the interior space.

In another embodiment of the present invention, a weather barrier such as moisture barrier may be combined with aerogel materials or aerogel blankets and used in any other embodiment of the present invention. Such materials include polymeric films, fiber reinforced composites,

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. Several embodiments of the present invention are described in the preceding paragraphs. Any combination of these embodiments or features may be combined and practiced unless it is specifically claimed otherwise. For example, FIG. 6 illustrates a battery enclosure and the description of FIG. 6 includes several specific embodiments for battery. However, it is to be understood that such specific embodiments may also be used with other embodiments of the present invention including for example, an enclosure for frozen food.

What is claimed is:

1. An enclosure comprising at least one wall, an interior space and a fiber reinforced aerogel wherein the aerogel is located in or about said at least one wall.

2. The enclosure of claim 1 wherein the aerogel material is in blanket form.

3. The enclosure of claim 1 or 2 wherein the aerogel material comprises: silica, titania, zirconia, alumina, hafnia, yttria, ceria or a combination thereof.

4. The enclosure of claim 1, 2 or 3 wherein the aerogel material comprises: urethanes, resorcinol formaldehydes, polyimide, polyacrylates, chitosan, polymethyl methacrylate, members of the acrylate family of oligomers, trialkoxysilylterminated polydimethylsiloxane, polyoxyalkylene, polyurethane, polybutadiane, melamine-formaldehyde, phenol-furfural or a combination thereof.

5. The enclosure of any of the preceding claims wherein the aerogel material comprises: silica-PMMA, silica-chitosan, silica-polyether or a combination thereof.

6. The enclosure of claim 2 further comprising a non-aerogel material.

7. The enclosure of claim 6 wherein the non-aerogel material comprises: elastomers, thermoplastics, thermosets, metals, semi-metals, ceramics, foams, biomaterials, or any combination thereof.

8. The enclosure of claim 7 further comprising a volume defined by the surfaces of said non-aerogel material.

9. The enclosure of claim 7 further comprising a volume defined by the surfaces of the aerogel blankets.

10. The enclosure of claim 8 wherein the aerogel material and non-aerogel material are secured to each other.

11. The enclosure of claim 1 further comprising a desiccant material, a heating element, a cooling element, a temperature sensor, a pressure sensor, a humidity sensor or a combination thereof.

12. The enclosure of claim 1 wherein said enclosure is flexible.

13. The enclosure of claim 1 wherein said enclosure contains a fluid wherein said fluid is characterized by a liquid, or
wherein said fluid is characterized by a gas, or
wherein said fluid is characterized by a mixture of a gas and a liquid.

14. The enclosure of claim 1 wherein the difference between the temperature of the interior space and the ambient is at least 5° C.

15. The enclosure of claim 13 wherein the fluid is at a cryogenic temperature.

16. The enclosure of claim 6 wherein the non-aerogel material is in a film form.

17. A method of enclosing an interior space comprising the steps of:
Providing at least a wall;
Providing a fiber reinforced aerogel in or about said at least one wall; and
Enclosing the interior space with the wall or the fiber reinforced aerogel.

18. The method as in claim 17 wherein the fiber-reinforced aerogel is attached to a polymeric layer.

19. The method of claim 17 further comprising the step of placing a cryogenic fluid in the interior space.

20. The method of claim 17 further comprising the step of placing a thermally sensitive material in the interior space.
